(19) United States
(12) Patent Application Publication
(10) Pub. No.: US 2008/0100636 A1
(43) Pub. Date: May 1, 2008

(54) Systems and Methods for Low-Power Computer Operation

(76) Inventors: Jiin Lai, Taipei (TW); Chin-Hwaun Wu, Taipei (TW); Ching-Hsiang Lin, Taipei (TW); Chin-Huei Wang, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 11/554,769

(22) Filed: Oct. 31, 2006

(51) Int. Cl. G09G 5/397

(52) U.S. Cl. 345/546; 715/867

(57) ABSTRACT

A computer system having low-power operation includes a controller in communication with a first storage device and a second storage device. The controller can be configured to periodically retrieve dynamic frame data from a first storage device during a time period when the computer system is not in an idle state. During a time period when the computer system is in an idle state, the controller is configured to store static frame data into a second storage device, and repeatedly retrieve the static frame data from the second storage device to display an image represented by the static frame data during a time when the computer system continues to be in the idle state.

### CROSS-REFERENCE TO RELATED APPLICATIONS

This application is related to U.S. patent application Ser. No. ______, entitled “Reducing Power During Idle State,” filed on the same day as this application, which is hereby incorporated by reference in its entirety.

### BACKGROUND

1. Technical Field

This disclosure relates to systems and methods for low-power computer operation and, more particularly, is related to reducing the power requirements of a computer system during periods of idle activity.

2. Description of the Related Art

An important consideration in the design of computer systems, and in particular, portable computing systems, is the reduction of overall power consumption. In this regard, computer systems can include a power-saving mode for assisting in the conservation of power. For example, operating systems can be configured to detect when a computer system has been idle for a predetermined period of time. Once idle for this time period, the operating system may inform a power management unit (PMU) associated with the computer system to control various hardware in the computer in order to save power. For example, once the power saving mode is entered, the PMU can provide a signal to hardware components associated with the computer system to instruct them to be power off or enter into a lower-power state in order to reduce the total power consumption.

To determine whether the computer system is idle, the operating system may determine whether the computer system is receiving inputs from a user or external devices or whether the computer is actively processing data (e.g. transcoding media, downloading content from the Internet, etc.), among other activities. However, even if a computer system is determined to be idle, it may be desirable that an associated display (e.g. a liquid crystal display (LCD) or a cathode ray tube (CRT)), provide an image provided by the computer.

Because the computer is idle, the displayed image may be a single frame which does not change until additional processing occurs (e.g. after the computer leaves the idle state and updates the frame image). In order to display the frame using such computer systems, a graphics engine and video driver work to continuously transmit the frame to the display. This continuous transmission refreshes the frame depicted in the display.

Thus, even though the frame being displayed may not change, the graphics engine is not capable of being placed into a low-power state. Rather, power continues to be consumed by the graphics engine and its associated components, such as graphics related memory, as if the computer system is not in the power-saving mode.

Further, computers configured using a unified memory architecture (UMA) suffer from additional power draining activity during this idle time. Specifically, a computer configured using a UMA uses a portion of the computer's main system memory for video memory. Thus, even when the computer enters the power-saving mode, the system memory and its associated control logic's power consumption can not be reduced because data in the system memory is being continually provided to the graphics engine to display the frame.

Accordingly, what is desired are systems and methods for low-power consumption that resolve the above-mentioned deficiencies, among others.

### SUMMARY

Systems and methods for low-power computer operation are disclosed. One embodiment of a method of computer system operation includes retrieving dynamic frame data from a first storage device during a time period when the computer system is not in an idle state. The method further includes, during a time period after the computer system has entered the idle state, storing static frame data into a second storage device, and repeatedly retrieving the static frame data from the second storage device for displaying an image represented by the static frame data during a time when the computer system continues to be idle.

One embodiment of a computer system includes a controller in communication with a first storage device and a second storage device, the controller configured to periodically retrieve dynamic frame data from a first storage device during a time period when the computer system is not in an idle state. During a time period when the computer system is in the idle state, the controller is configured to store static frame data into a second storage device, and repeatedly retrieve the static frame data from the second storage device for displaying an image represented by the static frame data during a time when the computer system continues to be in the idle state.

Another embodiment of a computer system includes means for controlling the flow of data in the computer system. The means for controlling the flow of data in the computer system comprises means for retrieving dynamic frame data from a first storage device during a time period when the computer system is not in an idle state, means for storing static frame data into a second storage device at a time period after the computer system has entered the idle state, and means for repeatedly retrieving the static frame data from the second storage device for displaying an image represented by the static frame data during a time when the computer system continues to be idle.

An embodiment of a computer system includes processing circuitry, system memory, and a display. The computer system includes logic for detecting an idle mode of operation of the processing circuitry. The computer system further includes idle state logic including: logic for placing contents of a frame buffer in the system memory into a dedicated display memory; logic for controllably directing the system memory into an idle mode of operation; and logic for continuing to operate the display such that the display presents visual information representative of the contents stored in the dedicated display memory

An embodiment of a method of computer operation includes detecting an idle mode of operation of processing circuitry. After detecting the idle mode of operation, contents of a frame buffer located in system memory are placed into a dedicated display memory. The system memory can be controllably directed into an idle mode of operation, and the display can continue to operate such that the display presents visual information representative of the contents stored in the dedicated display memory during a time period when the processing circuitry is in the idle mode of operation.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is an embodiment of a computer system configured for low-power computer operation.

FIG. 2 is a block diagram depicting an embodiment of the computer system of FIG. 1 in which a dedicated power-save frame buffer is used to implement the low-power operation of the computer system of FIG. 1.

FIG. 3 is a block diagram depicting an embodiment of a host and embedded graphics control hub that can be used with the computer system of FIG. 2.

FIG. 4 is a block diagram depicting another embodiment of the computer system of FIG. 1 in which a subset of the total system memory blocks are used as the power-save frame buffer for implementing the low-power operation of the computer system of FIG. 1.

FIG. 5A is a flow diagram depicting an embodiment of a process for low-power computer operation which may be implemented by the computer system of FIG. 1.

FIG. 5B is a continuation of the flow diagram of FIG. 5A.

FIG. 6 depicts a timing chart illustrating the operation of the low-power computer system of FIG. 1 and the process of FIG. 5.

### DETAILED DESCRIPTION

Computer systems can be configured to perform power saving operations during periods of idle activity. For example, the power consumption of some system components, such as memory and processing circuitry (i.e. processors in the Intel® x86 processor family) can be reduced during these idle periods of time. For example, if the computer is being used for the display of several pages of a Microsoft® PowerPoint® presentation, there can be long periods of time between the display of each sequential of slide. Although the computer system is not idle when called upon to retrieve and display the next slide, the time between the initial display of each slide requires very little computing activity. During such an idle time, among other power-saving measures, the processing circuitry and other computer components may enter into and out of one of a number of power states (i.e. C0, C1, C2, etc.) and other activities which are generally transparent to the end user. However, the user transparency presents problems with respect to power savings since the infrastructure used to display the image can be very power intensive, despite that the image may not change during this time. This power consumption becomes even more apparent in many conventional low-cost computing architectures, such as those that share memory modules for both video and system data.

Accordingly, systems and methods for low-power computer operation are disclosed herein that can, among other benefits, mitigate many of the problems associated with the power consumption of such conventional architectures. Using the described systems and methods, low-power computing can be achieved without interfering with the display of an image. In fact, the low-power operation can be designed to be unperceivable to a user. Accordingly, the described low-power operation can provide dramatic results considering that many computer systems remain idle for such long periods of time.

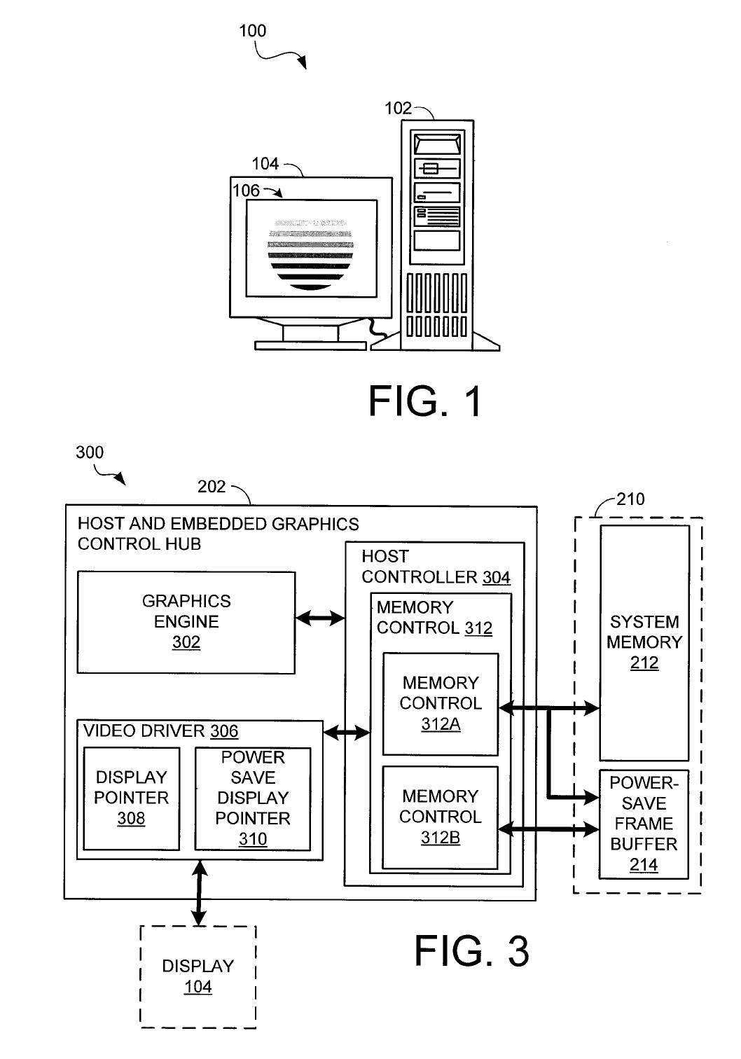

FIG. 1 depicts an embodiment of a system for low-power computer operation 100 including a computer system 102 and a display 104. Computer system 102 can be a general purpose or special purpose digital computer, such as a personal computer (PC; IBM-compatible, Apple-compatible, or otherwise), laptop computer, work-station, mini-computer, personal digital assistant (PDA), wireless phone, or main-frame computer, for example. Display 104 may be, for example, an LCD display, a CRT display, and/or a projector (i.e. an LCD projector or a digital-light processor (DLP) based projector). Display 104 receives a signal from computer system 102 that corresponds to a frame or image 106 to be displayed on a view screen of display 104. The image 106 could be any visual information that is to be displayed by system 100.

By way of example, at a time when computer system 102 is non-idle, a plurality of signals can be provided to display 104. These signals may correspond to the non-idle activity being performed by the computer system 102 (i.e. progress in processing a media file, playback of a multimedia file, etc.). However, at a time when the computer system is idle, image 106 could be a screen-saver image or a slide from a presentation. Even though computer system 102 may be idle and the image 106 does not change, the signals to display image 106 are continuously transmitted from computer system 102 to the display 104. For example, the computer system may provide the signals to display 104 at a frequency corresponding to the refresh rate of display 104 (e.g. 60 Hz).

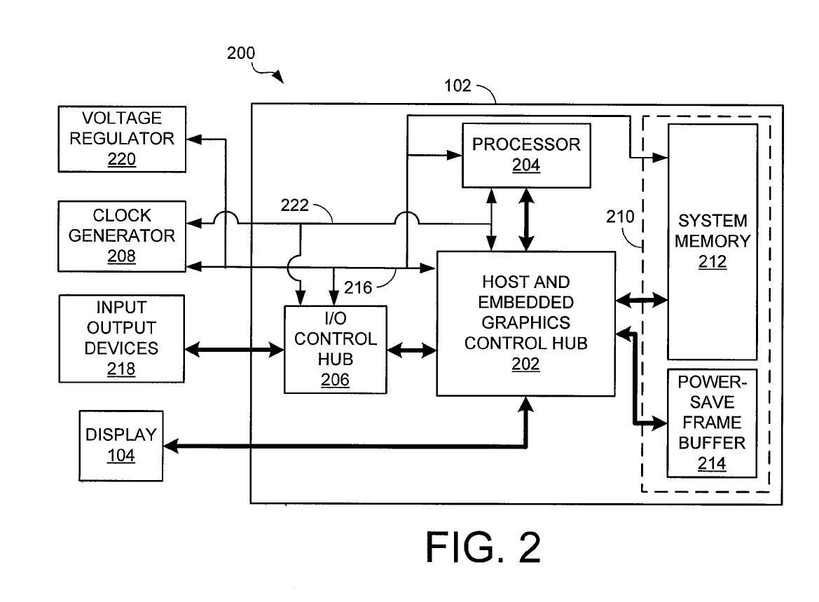

FIG. 2 is a block diagram of an embodiment 200 of the system for low-power operation 100 of FIG. 1 which can use a dedicated power-save frame buffer for implementing the low-power operation of computer system 102. Here, computer system 102 includes a number of devices which may communicate with one another across one or more busses. It will be appreciated that many common computer system devices that are not useful for describing the disclosed embodiments have been left out of the block diagram for simplicity in describing the more salient aspects of the system 100.

A host and embedded graphics control hub 202, for controlling the display of images 106 on display 104, can be in communication with a processor 204, input-output control hub 206, and memory 210 (which may include, among others, system memory 212 and a power-save frame buffer 214). In addition to fetching and storing data from memory 210 (i.e. for processor 204 and/or I/O control Hub 206), host and embedded graphics control hub 202 can perform data manipulation and graphic computations used to generate display image data. This display image data, later, is retrieved from memory and continuously provided to display 104.

A clock generator 208 can provide clock signals to drive I/O control hub 206, host and embedded graphics control hub 202, processor 204 and memory 210. Clock generator 208 can be configured to drive each component at different clock rates. Clock generator 208 can also be configured to receive a power-save signal 216, and upon receiving the power-save signal 216, can drive the clock rate of various computer system components at reduced rates (or may turn off the respective clock entirely). Once power-save signal 216 is no longer asserted, the clock generator can resume driving the component at the normal clock rate.

A voltage regulator 220 is capable of regulating the voltage supplied to the computer system 200 components, such as I/O control hub 206, host and embedded graphics control hub 202, processor 204 and/or memory 210. Similar to the clock generator 208, voltage regulator 220 can receive the power-save signal 216 and independently adjust voltage levels supplied to the various components accordingly.

Processor 204 can execute instructions that may be stored in one or more storage devices associated with computer system 102, which may include system memory 212 or others not depicted. Processor 204 could be, for example, a processor from the Pentium® family of processors available from Intel® Corporation of Santa Clara, Calif. or the Athlon®, Turion®, or Sempron® family of processors available from Advanced Micro Devices of Sunnyvale, Calif. These are, of course, merely examples, and other types of processors that may be used for various embodiments could include, among others, a digital signal processor (DSP), an application-specific integrated circuit (ASIC) or a general purpose processor.

According to some embodiments, computer system 102 can be a computer system complying with the unified memory architecture (UMA). Accordingly, computer system 102 may use a portion of the computer's main memory, here depicted as system memory 212, for video memory. Accordingly, the total available storage of system memory 212 can be shared between the host and embedded graphics control hub 202 and other computer system devices (e.g. processor 204 and I/O control Hub 206). Such a configuration may also be referred to as a shared-memory architecture (SMA), which can reduce the cost and/or complexity of the system architecture of computer system 102. System memory 212 may include be among others, dynamic random access memory (DRAM).

As will be described in more detail below, since system memory 212 is used for video memory, at times when computer system 102 is not in a power-save mode, frame data generated by components within host and embedded graphics control hub 202 can be temporarily stored in, and retrieved from, system memory 212. Thus, system memory 212 can include a logical frame buffer for storing the frame data. This frame data may be referred to as dynamic frame data because new frames are continuously being generated and stored into the system memory 212 for subsequent display.

According to embodiment 200, in addition to system memory 212, a separate power-save frame buffer 214 may be included. Power-save frame buffer 214 may be, among other possible memory types, dynamic random access memory (DRAM) or static random access memory (SRAM). Power-save frame buffer 214 can be dedicated for holding frame data at a time when computer system 200 is in a power-save mode. Such frame data may include the information needed to display a single image 106 (or more if desired) within display 106.

The frame data stored in power-save frame buffer may also be referred to as static frame data in that the frame data stored therein does not change while the computer system is idle. Thus, static frame data is frame data that is not updated and remains unchanged until the next idle period. In this respect, power-save frame buffer 214 functions, and may be referred to herein, as a static frame-data buffer. It should also be understood that static frame data could include more than one frame of data, such as if needed to display a loop of an animated image without the need for the computer system to leave the idle state.

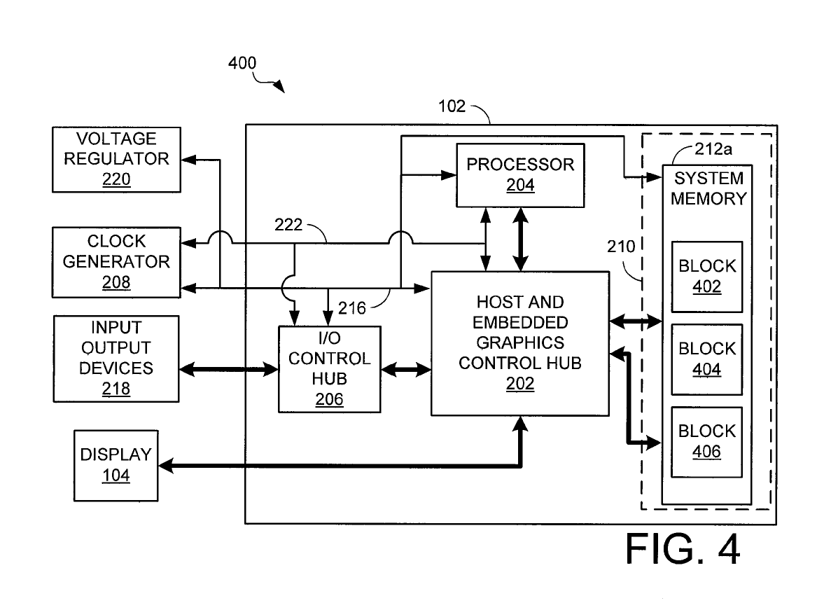

Looking now to FIG. 3, an embodiment of the host and embedded graphics control hub 202 may include, among other modules, a graphics engine 302, a host controller 304 and a video driver 306. Graphics engine 302 can be a processor configured to perform the graphic computations that are used to produce frame data that corresponds to image 106. Accordingly, graphics engine 302 can process graphics and video commands received from host controller 304 or other devices associated with computer system 102 to generate the frame data that is placed into a display frame buffer. The content of this frame data can, for example, consist of color values for each pixel to be displayed on the screen of display 104, and the total memory required to hold this frame data is dependent upon, for example, the resolution and color depth of the output signal.

The frame data produced by graphics engine 302 can be stored temporarily in memory and provided to video driver unit 306 to generate the image 106 (FIG. 1) that represents the contents of the frame data stored in memory (i.e. in a frame buffer). Video driver unit 306 may, for example, provide a signal to display 104 at a desired frequency based on the frame data. Video driver 306 may include at least one pointer which refers to the location in memory that the frame data is located. For example, according to some embodiments, video driver 306 may include a display pointer 308 and a power-save display pointer 310. These pointers can address a memory location of the current frame buffer, which may be stored in system memory 212 or power-save frame buffer 214, respectively.

Host controller 304 may comprise a memory controller 312 capable of controlling the flow of data between one or more storage devices and the graphics engine 302, processor 204 and I/O control hub 206. For example, host controller 304 can store and retrieve data from the storage devices, such as the memory devices of memory 210. Accordingly, host controller 304 may communicate with graphics engine 302 to provide data from memory 212 to the graphics engine 302 and to store resulting frame data. Video driver 306 may also use host controller 304 for retrieving the frame data from memory 210 that is used to for depicting the image 106 on display 104. Host controller 304 may also provide the graphics and video commands to graphics engine 302.

In operation, when computer system 102 is not in a power-save mode, memory control 312 retrieves data used for displaying an image 106 in display 104 from system memory 212, graphics engine 302 performs the graphic computations needed to generate the frame data used for displaying an image on display 104, and memory control 312 stores the generated frame data to the system memory frame buffer of system memory 212. While computer system 102 is not in the power-save mode, display pointer 308 provides the memory address for the system memory frame buffer of system memory 212. Accordingly, video driver 306 provides display pointer 308 to memory control 312 to retrieve and provide this frame data to video driver 306. Video driver 306 can then display the image represented by the retrieved frame data. This process is continuously repeated to dynamically update the frame data and display the corresponding images in display 104.

Thus, while computer system 102 is not in a power-save mode, the process of updating the display with the latest image uses the various computer system components at a capacity up to the full operating capacity. For example, the memory 212, graphics engine 302, video driver 306, and host controller 304 of the host and embedded graphics control hub 202 can all be operated at up to full capacity (e.g. full voltage and/or clock speed). It should be understood that when the computer system 102 is not in power-save mode, these components may be actually operated at a level that is not idle, but is also not full capacity.

However, when computer system 102 is idle, the image 106 displayed typically does not change. Referring to the example of a slide presentation, the frame data may represent a static image being displayed via the display 104 during the presentation. Regardless, system memory 212 is powered in its full operational state in that the frame data stored therein is continuously accessed for display of its respective image 106. Additionally, the various components of the embedded graphics control hub 202 operate to continuously display the static image as described above.

Accordingly, in order for computer system 102 to provide low-power operation, among other system components, graphics control hub 202 may be configured to operate in a power-saving mode once computer system 102 is idle for a predetermined amount of time and/or once no more graphics or video commands to be processed by the graphics engine 302 are remaining. Accordingly, once computer system 102 is idle for the predetermined amount of time (which may place computer system 102 in its own power-saving mode) and/or once no more graphics or video commands to be processed by the graphics engine 302 are remaining, memory control 312 can place the contents of the system memory frame buffer of system memory 212 into the power-save frame buffer 214. Specifically, video driver 306 displays the latest image 106 and retrieves the frame data from the system memory frame buffer of system memory 212 and, at substantially the same time, this dynamic frame data can be stored as static frame data into power-save frame buffer 214.

Once the frame data is stored in power-save frame buffer 214, video driver 306 can update the pointer used to access the frame data to the power-save display pointer 310, causing memory control 312 to fetch the static frame data from power-save frame buffer 214 during the idle period. Accordingly, display 104 continues to operate to present visual information representative of the content stored in the power-save frame buffer 214. Upon computer system 102 awakening from the idle state and/or the display image 106 is modified by processor 204 and/or graphics control hub 202, the power-save mode is completed and the frame-buffer pointer can be reset to display pointer 308 for retrieving the next set of frame data from the frame buffer within system memory 212 to be used for displaying the updated image 106.

Copying the frame data to the power-save frame buffer 214 can enable a number of aggressive power-saving operations. For example, once the frame data is copied into the power-save frame buffer 214, host controller 304 no longer requires access to system memory 212 for retrieving the frame data. Thus, system memory 212 can be directed into an idle mode of operation in order to reduce overall system power. For example, system memory can be placed into a low-power, self-refresh state. Because system memory 212 is normally controlled by memory control 312 at a high-power consumption operational state with high clock speed (i.e. 400/533/667/800 MHz in DDR mode) during non-idle periods, the resulting power savings can be substantial.

These power savings are especially significant in that power-save frame buffer 214 can be configured to require much less power for its operation relative to system memory 210. For example, power-save frame buffer 214 may be much smaller in size, operate at a lower clock frequency, be manufactured with lower voltage requirements, and/or use technology that requires less power (i.e. SRAM vs. DRAM) in comparison to system memory 212. According to one embodiment, system memory 212 could be several gigabytes of DRAM, while power-save frame buffer 214 could be a 256 Mb DRAM memory chip, 32 MB DRAM memory chip, or a chip being even smaller in storage size. It should be understood that the actual size of power-save frame buffer 214 may depend on factors such as the desired resolution or color depth of the image 106, which determines the size of the corresponding frame data to be stored therein. Additionally, practical considerations, such as the commonly available sizes of such memory chips, may also influence the configuration of power-save frame buffer 214. However, according to some embodiments, power-save frame buffer 214 may be sized to hold just enough frame data to display a single image 106 or loop of images. Accordingly, power-save frame buffer 214 can be a dedicated for the purpose of holding the frame buffer during idle states and can be operated using less power because of its relative size and/or lower operating clock frequency in comparison to system memory 212.

Additionally, among other power-saving possibilities, clock generator 208 can stop or slow the clock of designated components and voltage regulator 220 can lower the core voltage of designated components that are not used during the idle period.

Thus, the clock sources of idle functional modules can be gated off and the phase lock loop (PLL) can be turned off. Unlike conventional systems in which the host and embedded graphics control hub 202 maintains normal power-consumption during idle states, many of the unused components of the disclosed embedded graphics control hub 202 can be placed into a low-power state to enable further power-saving. For example, the operational clock of the graphics engine 302 can be stopped.

Host and embedded graphics control hub 202 may, for example, be controlled to enter or leave the power-save mode by directly detecting an idle state of the computer system and/or by receiving a signal from another computer system component that indicates that the computer system is idle. For example, according to one embodiment, graphics control hub 202 may be informed of the state of processor 204 (i.e. C0, C1, C2, C3, etc.) and enter the power-save mode upon the processor entering a specified state. According to another embodiment, graphics control hub 202 may receive a signal from a controller such as input/output control 206.

According to an embodiment in which input/output control 206 provides the indication that the computer system is idle, an optional state indication signal, depicted as power-save signal 216, can be asserted by input/output control 206 to enable the system 102 to perform the aggressive power reduction actions while allowing the visible screen display of image 106 to remain intact. For example, input/output control 206 may be in communication with processor 204 and/or other computer system components in order to detect the idle state of the computer system 102.

Once the idle state is detected and/or once no more graphics or video commands to be processed by the graphics engine 302 are remaining, power-save signal 216 can be provided to voltage regulator 220 and/or clock generator 208 to control the voltages and/or clock signals of various components as described above. According to some embodiments, power-save signal 216 may be provided directly to the system components, such as host and graphics control hub 202, and/or processor 204, among other components within system 102 that could be directed into power saving modes during the idle period. Accordingly, input/output control 206 could also direct input/output devices 218 to enter into (or leave from) their respective power-save modes.

Input/output control 206 may be in bi-directional communication with embedded graphics control hub to coordinate the power-saving operations. For example, the signal 216 may be first provided to embedded graphics control hub 202, and once the frame data is copied into the power-save frame buffer (i.e. after receiving a return signal from graphics control hub 202 indicating that the frame data has been copied), the power-save signal can be asserted to the other computer system components, such as voltage regulator 220 and clock generator 208.

According to embodiments in which graphics control hub 202 directly detects the computer system idle state, the graphics control hub 202 may communicate with input/output control hub 206 to indicate that the power-save signal can be asserted to the other components once the frame data is safely copied into the power-save frame buffer.

According to some embodiments, host controller 304 comprises a single memory control 312A that is configured to store and retrieve data to and from both system memory 212 and power-save frame buffer 214. Memory control 312A may be operated in at least two speeds, the first high-clock rate speed corresponding to normal (non-idle) operation and a second low-clock rate speed corresponding to low-power operation during the idle period. During non-idle operation, video driver 306 fetches frame data through memory control 312A using display pointer 308. During idle states, video driver 306 fetches frame data through memory control 312A using power-save display pointer 310, possibly at a lower clock speed to minimize power consumption.

However, according to some embodiments, host controller 304 includes a second, dedicated memory control 312B that can be configured to store and retrieve data to and from power-save frame buffer 214 at a reduced operational speed, such as at the video driver 306 clock rate. During the idle period memory control 312B can supply frame data to video driver 306 at the reduced clock rate, and memory control 312A can enter a power-saving mode. For example, memory control 312A can be powered off or its operational clock can be stopped. Once the idle period is over memory control 312A can again be used to provide data to and from graphics engine 302 and supply frame data from system memory 212 to video driver 306.

Accordingly, among other benefits that will become apparent to one skilled in the art, the system memory bus input/output power consumption can be mitigated (or eliminated in some embodiments), system memory power consumption can be substantially minimized, power consumption from clock sources of idle functional modules can be eliminated, and the power consumption from the memory controller within the graphic control hub can be reduced. Further, idle components within the host and embedded graphics control hub 202, such as graphics engine 302 (and, potentially, memory control 312A) can be directed into a power-saving mode. Additionally, the memory controller for the power-save frame buffer 214 can operate at an adaptive frequency based on, for example, the frequency of video driver 306 during the power-save mode. This is in comparison to the non-power save mode, in which the memory control 312 frequency may run at the frequency of the system memory 212, which can be much higher than the display frequency.

Upon leaving the idle state, the power-save signal 216 can be de-asserted to alert system components, such as voltage regulator 220 and clock generator 208, that the voltages and clock signals previously reduced can be returned to the non-idle state. Additionally, the idled components within the host and embedded graphics control hub 202 return to non-idle state. The video driver 306 returns to using display pointer 308 to fetch the next set of frame data, once it is modified from the frame buffer within system memory 212.

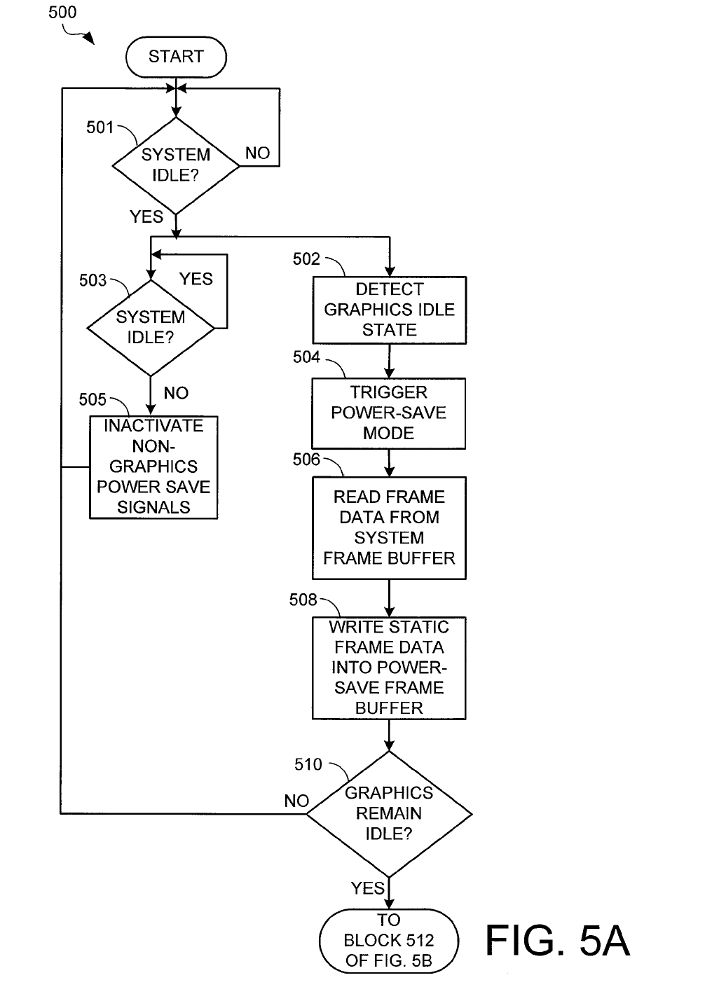

Looking now to FIG. 4, another embodiment of a system for low-power operation 400 of a computer system is depicted. System 400 shares many of the same features and components as the previously described system 200 of FIG. 2. However, in contrast to system 200, system 400 uses a sub-set of system memory as the low-power frame buffer. In nearly all respects, the embodiments of system 400 can be identical to the embodiments of system 200, with the exception of using the subset of system memory 212a in place of the dedicated frame buffer of system 200. The selected subset of system memory 212a effectively becomes the power-save frame buffer.

For example, system memory 212a of system 400 can comprise a plurality of memory blocks 402, 404 and 406. Again, each of memory blocks 402-406 may be physical DRAM modules which may be individually controlled to enter into a power-saving mode (i.e. a low-power refresh state, etc.). A subset of memory blocks 402, 404 or 406 can be used for storing the static frame data to be used by video driver 306 for displaying the image during the idle period. Any blocks not used to store the static frame data can be directed to enter the power-saving mode during the idle period. The subset of memory blocks could be block 402, for example, and upon detecting that computer system 102 has been idle for the predetermined duration and/or once no more graphics or video commands to be processed by the graphics engine 302 are remaining, the static frame data can be stored within block 402 of system memory 212a. According to this example, memory blocks 404 and 406 could then be placed into the power-saving mode (e.g. a low-power, self-refresh state) while maintaining a normal, or relatively higher, system power to block 402. According to this example, the memory control 312 of graphic control hub 202 can retrieve the static frame data from block 402 during the idle period. During the idle period, the clock frequency of block 402 could also be reduced to the clock speed needed for video driver 306 to properly display the image, just as performed with the power-save frame buffer 214 of system 200.

Accordingly, additional power savings can be achieved by asserting the power-save signal 216 during the idle duration as described in the embodiment of system 200 to place other related computer system 102 components into their respective low-power states as described previously with respect to system 200. This could include, for example, reducing the voltage and/or clock frequency supplied to idle system components.

According to some embodiments, the dynamic frame data may be fragmented across memory blocks 402-406. Accordingly, it may be necessary to initially copy the fragmented dynamic frame data from one or more of memory blocks 402-406 into the subset of memory blocks being used for storing the static frame data. According to one embodiment, any fragmented frame data in blocks 404 and 406 may be copied to addressable locations within block 402 before reducing the power to blocks 404 and 406 and/or taking other power-saving measures.

In many applications, memory blocks 402-406 will be relatively large in comparison to the amount of static frame data stored for the purpose of displaying the image 106 in display 104. For example, each of memory blocks 402-406 may comprise a 1 GB stick of DRAM, for a total of 3 GB of system memory 212a. However, in some embodiments, only 32 MB of memory (or less) may be needed for storing the static frame data. In general, there is a relationship between the amount of addressable memory and its respective power consumption. Accordingly, the power consumption of the large memory system memory block used to hold the static frame data (i.e. in this example, block 402) may be relatively large in comparison to the amount of power consumed by a dedicated frame buffer having a dramatically smaller amount of addressable memory. Thus, in some cases, more dramatic power reduction can be achieved using a dedicated power-save frame buffer 214 (FIG. 2) that is appropriately sized for its purpose. However, the embodiment of system 400 may be useful, for example, in pre-existing systems which were not designed with the dedicated power-save frame buffer 214.

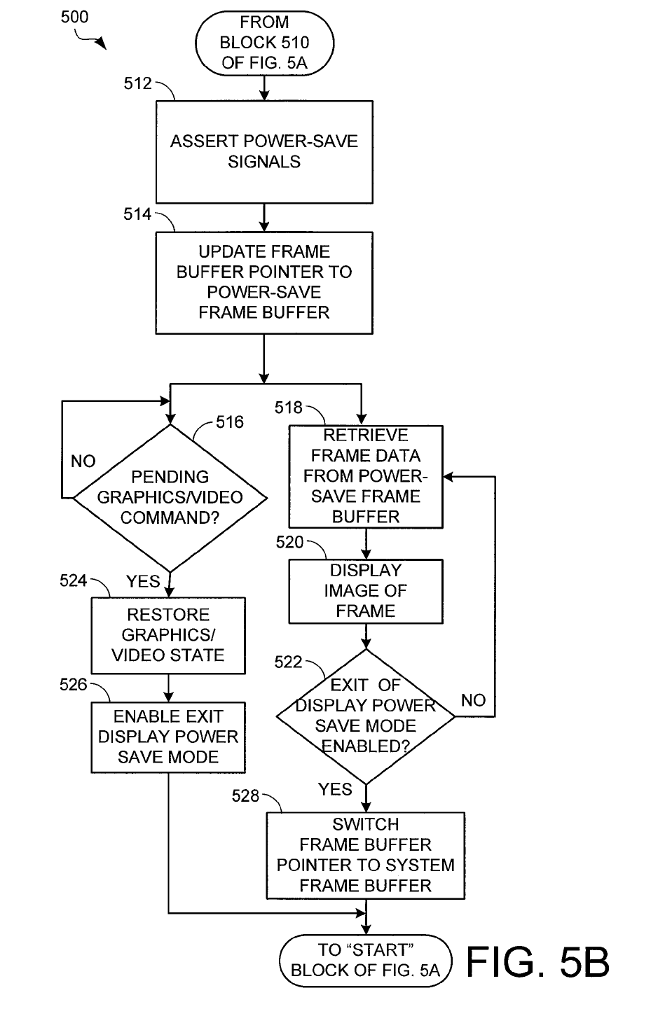

FIGS. 5A and 5B depict a flow diagram for a process 500 for low-power computer operation. Process 500 may be implemented by the system 100, including the embodiments 200 and 400 of FIGS. 2 and 4, respectively. Any process descriptions, steps, or blocks in flow diagrams should be understood as potentially representing modules, segments, or portions of code which include one or more executable statements for implementing specific logical functions or steps in the process, and alternate implementations are included within the scope of the preferred embodiments of the systems and methods of low-power computer operation in which functions may be deleted or executed out of order from that shown or discussed, including substantially concurrently or in reverse order, depending on the functionality involved, as would be understood by those reasonably skilled in the art.

At block 501 of FIG. 5A the computer system 102 is monitored until an idle state is detected. For example, the idle state could be detected by monitoring the state of the processing circuitry and/or by notification from the operating system that the processing circuitry is idle. For example, the state of processor 204 (i.e. C0, C1, C2, etc.) can be monitored, and upon the processor entering a predefined state the computer system 102 can be determined to be idle. When not idle (the NO condition), the computer system continues to wait for an idle state. However, upon detecting an idle state (the YES condition), at block 503 the computer system can continue to monitor the idle state while the various power-saving features are carried out substantially simultaneously. If the computer system is detected as having left the idle state (the NO condition of block 503), at block 505 any non-graphics related power save signals that were previously asserted to various components associated with computer system 102 can be de-asserted, returning such components to their normal operation, while the display system stays in the power-save display mode until a graphics/video command is received (e.g. at block 516) and the system frame buffer in system memory 212 is modified.

At block 502 of FIG. 5A, the graphics engine 302 is monitored to determine when it becomes idle. For example, according to some embodiments, graphics engine 302 is determined to be idle once no more graphics or video commands to be processed by the graphics engine 302 are remaining. At block 504, power-save mode is triggered. For example, according to such an embodiment, power-save mode can be triggered after the computer system is idle for an amount of time (block 503) and after the graphics engine 302 has processed all the pending commands (block 502). According to some embodiments, however, power-save mode may be triggered by one of the computer system being detected as being idle or the graphics engine being detected as being idle, among other events, such as by receiving a signal from another computer system 102 component or via the operating system.

At block 506, the frame data corresponding to the frame image to be displayed during the idle period is read from the system memory frame buffer of system memory. This dynamic frame data may be the last frame data used to display an image before entering the idle period. At block 508, the last frame image copied from the system frame buffer of system memory is stored into the power-save frame buffer (i.e. a static frame image is copied into the static frame-data buffer). This operation may be performed by memory control 312A as directed by of video driver 306. However, the copying can be performed by the dedicated low-clock rate memory control 312B if using this additional memory controller. Also, the storing operation of block 508 can be performed concurrently by memory control 312A or 312B while display driver 306 is retrieving the last frame's image data from system frame buffer and sent to display 104.

At decision block 510, if the graphics engine 302 exits the idle state (the NO condition) the process returns to block 501 to detect when the computer system 102 returns to an idle state. However, if the graphics engine 302 continues to be idle (the YES condition) the process continues to block 512 of FIG. 5B.

At block 512, now that the frame has been copied into the power-save frame buffer, power-save signals are asserted to various devices. Specifically, the power-save signal indicates to such devices that they may enter their respective power-save mode. Among others, the signal may be asserted to voltage regulator 220 and clock generator 208. Thus, voltage regulator 220 may then lower the core voltage of selected system components. Likewise, clock generator 208 may reduce the clock frequency, or eliminate the clock signal entirely, from selected system components. For example, among other devices, the voltage and/or clock frequency of one or more blocks of system memory can be reduced.

At block 514, the frame buffer pointer can be updated from an address of the frame buffer of system memory to an address of the power-save frame buffer. For example, video driver 306 can use power-save display pointer 310 instead of display pointer 308.

At block 516 the computer system is monitored to determine whether a graphics and/or video command is received and/or processed by the graphics engine 302, which indicates that the display image may be modified. So long as no graphics/video commands are pending (the NO condition), blocks 518-522 are repeated to display the image stored in the frame buffer to display 104.

Specifically, at block 518, video driver 306, through memory control 312, can retrieve the static frame data from the power-save frame buffer using the updated frame buffer pointer address. At block 520, video driver 306 can display the image 106 represented by the static frame data retrieved from the power-save frame buffer in display 104.

At decision block 522, a determination is made as to whether the computer system continues to be in the idle state. For example, if a graphics/video command has been detected at block 516 (the YES condition of block 516), at block 524 the graphics/video state is restored so that the graphics engine 302 can execute the received commands right away while the display system is in the state of block 518 and block 522, and if needed, update the system frame buffer in system memory 212.

At block 526 the computer system enables the exit of the display power-save mode (e.g. by setting a flag or sending an event indicating that such state has changed), so that later, the test on decision block 522 will be true (the YES condition), and, at block 528, the video driver will switch to display pointer 308 to retrieve frame data from the system frame buffer in the system memory 212 and return to normal operation.

If the display image has not changed and the display power-save mode is enabled (the YES condition of block 522), video driver 306 can continue to retrieve the frame data from the power-save frame buffer and display the resulting image by repeating blocks 518 and 520. However, once the display image is modified and the display power-save mode is disabled (the YES condition of block 522), at block 528, the frame buffer pointer can then be updated to an address back in the system frame buffer and exit from the power-save display mode. For example, video driver 306 can use display pointer 308 instead of power-save display pointer 310. The process then returns to the start of process 500 to detect the next time the system becomes idle.

According to the process 500, it should be understood that according to some embodiments, the power-save frame buffer (i.e. the static frame-data buffer) could be a dedicated power-save frame buffer as in system 200 (FIG. 2). According to other embodiments, the power-save frame buffer could comprises a subset of the memory blocks of the system memory 212a, as in system 400 (FIG. 4). Additionally, at the time that the power-save signal is asserted at block 512, other computer components may be powered off or otherwise directed to enter a respective low-power consumption state by receiving the power save signal and/or by an adjustment to their core voltage or clock speed.

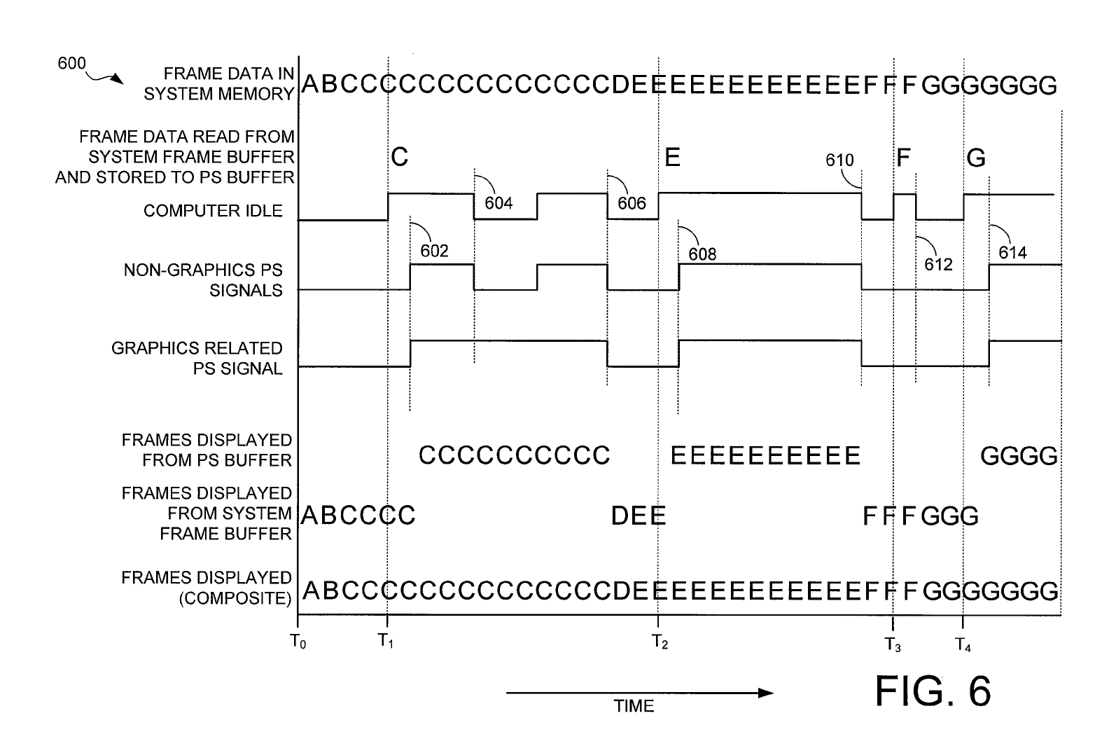

FIG. 6 depicts a timing chart 600 that further describes the operation of the systems and methods for low-power computer operation. Frame data A-G (“FRAME DATA IN SYSTEM MEMORY”) corresponds to a plurality corresponding images A-G to be displayed. For example, some frames are displayed from the power-save frame buffer (“FRAMES DISPLAYED FROM PS FRAME BUFFER”) and some frames are displayed from the system frame buffer (“FRAMES DISPLAYED FROM SYSTEM FRAME BUFFER”), where the combination of the frames displayed from each of the power-save frame buffer and the system frame buffer are depicted in the row entitled “FRAMES DISPLAYED (COMPOSITE).” During the time period defined from To just before T1 the computer system is not idle and the frame data in the system memory is used for displaying a corresponding image.

At time T₁, the computer system is detected as being in an idle state. Additionally, no graphics/video commands are processing, indicating that the frame data in system memory, depicted as frame “C”, has not changed for a predetermined time period. Accordingly, after detecting the computer is idle and/or no graphics/video commands are being processed for a short period of time, power-save mode is begun and the frame data (here, frame “C”) is read from the system memory at time T₁, transmitted to display 104, and simultaneously stored into the power-save frame buffer just after time T₁. The power-save frame buffer could be a subset of the blocks of system memory or could be a dedicated memory buffer that is separate altogether from the system memory. Once power-save mode has started, power-save signals can be asserted to non-graphics related devices (“NON-GRAPHICS PS SIGNALS”) and to graphics related devices (“GRAPHICS RELATED PS SIGNAL”) as depicted by the respective signals moving to the high state at time 602.

The static frame data stored into the power-save frame buffer (i.e. frame “C”) can then be accessed from the power-save frame buffer for displaying the corresponding image (i.e. image of frame C) on the display until the computer system is no longer idle and/or the frame data changes (e.g. pending graphics or video commands are detected/processed at graphics engine 302). While computer system 200 is idle and continuously displaying static image C, other devices within the computer system receiving power-save signals can be placed in a power-saving mode.

At time 604, the computer is no longer detected as being idle, but the frame data has not changed. Thus, although non-graphics related power-save signals can be de-asserted, the graphics related power-save signals can remain asserted and frame C can remain being displayed from the power-save frame buffer.

At time 606, however, the computer system is detected as being not being idle and a change in the frame data, from frame C to frame D occurs. Accordingly, both the non-graphics related and graphics related power-save signals are deasserted and the frame buffer pointer is updated to an address in the system memory (i.e. the address of frame D). Accordingly, subsequent images of frames D and E are displayed by the computer system from the system frame buffer from approximately time 606 to time T₂.

At time T₂ the computer system again is detected as being idle and the frame data has not changed, having been frame E for a predefined time period. At time 608, the graphics and non-graphics related power save signals are asserted and frame E is displayed from the power-save frame buffer until time 610 when the computer system is no longer detected as idle and the frame data changes from frame E to frame F.

At time T₃, the computer system again is detected as being idle and the frame data has not changed, having been frame F for a predefined time period. Frame F is then copied to the power-save frame buffer. However, just after copying frame F to the frame buffer at time 612, the computer system is no longer idle and the frame in system memory changes to frame G. Thus, the frames continue to be displayed from the system memory frame buffer from time 610 to just after T₄.

At time T₄ the computer system is again detected as being idle and the frame data has not changed, having been frame G for a predefined time period. At time 614 the graphics and non-graphics related power save signals are asserted and frame G is displayed from the power-save frame buffer until the computer system is no longer idle and/or the frame data changes.

It should be emphasized that the above-described embodiments, particularly any preferred embodiments, are merely possible examples of implementations, merely set forth for a clear understanding of the principles of the systems and methods, many variations and modifications may be made to the above-described embodiments without departing substantially from the principles of the disclosure.

1. A method of computer system operation comprising:
retrieving dynamic frame data from a first storage device during a time period when the computer system is not in an idle state, and during a time period after the computer system has entered the idle state:
storing static frame data into a second storage device; and
repeatedly retrieving the static frame data from the second storage device for displaying an image represented by the static frame data during a time when the computer system continues to be idle.

2. The method of claim 1, wherein the step of storing static frame data into a second storage device comprises:
retrieving at least a portion of the dynamic frame data from the first storage device at a time when displaying a frame based on the frame data; and
storing the portion of the dynamic frame data into the second storage device.

3. The method of claim 1, wherein the step of storing static frame data into the second storage device comprises storing the static frame data into a dedicated power-save frame buffer.

4. The method of claim 1, wherein the step of retrieving dynamic frame data from the first storage device comprises retrieving the dynamic frame data from memory shared by a graphics controller and a central processing unit.

5. The method of claim 1, wherein the step of retrieving the dynamic frame data from the first storage device comprises retrieving the dynamic frame data from a plurality of memory blocks, and the step of storing static frame data into a second storage device comprises storing static frame data into a subset of the plurality of memory blocks.

6. The method of claim 5, further comprising:
sharing the plurality of memory blocks between a graphics controller and a central processing unit.

7. The method of claim 1, further comprising:
updating a frame buffer pointer to a memory address of the static frame data stored in the second storage device.

8. The method of claim 7, further comprising:
asserting a power-save signal during a time that the computer system is idle, the signal indicating that devices receiving the signal may enter a power-saving mode.

9. The method of claim 8, further comprising:
reducing the power consumption of the first storage device from a first power consumption level to a second power consumption level at a time after the power-save signal is asserted.

10. The method of claim 9, further including:
updating the frame-buffer pointer to a memory address of the dynamic frame data stored in the first storage device at a time after the computer system is no longer idle.

11. The method of claim 9, further comprising:
increasing the power consumption of the first storage device from the second power consumption level to the first power consumption level at a time when the computer system is no longer idle.

12. A computer system comprising:
a controller in communication with a first storage device and a second storage device of the computer system, the controller for retrieving dynamic frame data from a first storage device during a time period when the computer system is not in an idle state, and during a time period when the computer system is in the idle state, the controller:
stores static frame data into a second storage device; and
retrieves the static frame data from the second storage device for displaying an image represented by the static frame data during a time when the computer system continues to be in the idle state.

13. The system of claim 12, wherein the controller stores static frame data into the second storage device by:
retrieving at least a portion of the dynamic frame data from the first storage device at a time when displaying a frame based on the frame data; and
storing the portion of the static frame data into the second storage device.

14. The system of claim 12, wherein the controller stores the static frame data into the second storage device by storing the static frame data into a dedicated power-save frame buffer.

15. The system of claim 12, wherein the controller retrieves the dynamic frame data from the first storage device by retrieving the dynamic frame data from memory shared by a graphics controller and a central processing unit.

16. The system of claim 12, wherein the controller further:
retrieves the dynamic frame data from the first storage device by retrieving the dynamic frame data from a plurality of memory blocks; and the
store the static frame data into the second storage device by storing the static frame data into a subset of the plurality of memory blocks.

17. The system of claim 16, wherein the controller shares the plurality of memory blocks between a graphics controller and a central processing unit.

18. The system of claim 12, wherein the controller is further configured to update a frame buffer pointer to a memory address of the static frame data stored in the second storage device.

19. The system of claim 18, wherein the controller is further configured to assert a signal during a time that the computer system is idle, the signal indicating that devices receiving the signal may enter a power-saving mode.

20. The system of claim 19, wherein the computer system is configured to reduce the power consumption of the first storage device at a time after the power-save signal has been asserted.

21. The system of claim 20, wherein the computer system is configured to increase the power consumption of the first storage device when the computer system is no longer idle.

22. The system of claim 20, wherein the controller is configured to update the frame-buffer pointer to a memory address of the dynamic frame data stored in the first storage device at a time after the computer system is no longer idle.

23. A computer system comprising:
means for controlling the flow of data in the computer system comprising:
means for retrieving dynamic frame data from a first storage device during a time period when the computer system is not in an idle state;
means for storing static frame data into a second storage device at a time period after the computer system has entered the idle state; and
means for repeatedly retrieving the static frame data from the second storage device for displaying an image represented by the static frame data during a time when the computer system continues to be idle.

24. The system of claim 23, further comprising:
means for updating a frame buffer pointer to a memory address of the static frame data stored in the second storage device.

25. The system of claim 24, further comprising:
means for asserting a signal during a time that the computer system is idle, the signal indicating that devices receiving the signal may enter a power-saving mode.

26. The system of claim 25, further comprising
means for receiving the signal at the controller of the first storage device; and
means for reducing the power consumption of the first storage device at a time after the controller of the first storage device receives the power-save signal.

27. The system of claim 26, further comprising:
means for updating the frame-buffer pointer to a memory address of the dynamic frame data stored in the first storage device at a time after the computer system is no longer idle.

28. The system of claim 26, further including:
means for increasing the power consumption of the first storage device when the computer system is no longer idle.

29. A computer system comprising:
processing circuitry, system memory, and a display;
logic for detecting an idle mode of operation of the processing circuitry; and
idle state logic comprising:
logic for placing contents of a frame buffer in the system memory into a dedicated display memory;
logic for controllably directing the system memory into an idle mode of operation; and
logic for continuing to operate the display such that the display presents visual information representative of the contents stored in the dedicated display memory.

30. The computer system of claim 29, wherein the idle-state logic further comprises:
logic for controllably directing graphics processing circuitry into a low-power mode of operation.

31. The computer system of claim 29, wherein the idle-state logic further comprises:
logic for controllably directing system power and clock circuitry into a low-power mode of operation.

32. A method of computer operation comprising:
detecting an idle mode of operation of processing circuitry, and after detecting the idle mode of operation:
placing contents of a frame buffer located in system memory into a dedicated display memory;
controllably directing the system memory into an idle mode of operation; and
continuing to operate the display such that the display presents visual information representative of the contents stored in the dedicated display memory during a time period when the processing circuitry is in the idle mode of operation.

33. The method of claim 32, further comprising:
controllably directing graphics processing circuitry into a low power mode of operation at a time after detecting the idle mode of operation.
